(19) United States
(12) Patent Application Publication
(10) Pub. No.: US 2020/0023834 A1
(43) Pub. Date: Jan. 23, 2020

(54) ASSISTED DRIVING SYSTEM FOR CLEARANCE GUIDANCE

(71) Applicant: Byton North America Corporation, Santa Clara, CA (US)

(72) Inventor: Srini Gowda, Solihull (GB)

(21) Appl. No.: 16/042,310

(22) Filed: Jul. 23, 2018

(51) Int. Cl. B60W 30/09; G06K 9/00; B60Q 9/00; G05D 1/02; G05D 1/00; B60W 50/14

(52) U.S. Cl. CPC B60W 30/09; G06K 9/00805; B60Q 9/008; G05D 1/0246; G05D 1/0276; G05D 1/0257; B60W 2710/20; G05D 1/0088; B60W 50/14; B60W 2550/10; G05D 2201/0213; B60W 2710/18; G05D 1/0255

(57) ABSTRACT

An assisted driving system can provide forward clearance guidance for a vehicle by using data about an object attached to the vehicle and data about a space in an expected path of travel of the vehicle. The data about the object can be input into the vehicle's data processing systems through a mobile application on a driver's smartphone, and the mobile application can be configured to exchange information with the vehicle's data processing systems through a wired (e.g. USB) or wireless (e.g., Bluetooth) interface.

### BACKGROUND

The field of this disclosure relates to vehicles such as automobiles (for example a sport utility vehicle—SUV), buses, trucks, etc.

Present day vehicles often allow the addition of objects that can be added to the vehicle. For example, an automobile, such as an SUV, can include a rack on the roof of the automobile, and the rack can hold a bicycle or luggage or other objects. The ability to add an object to the vehicle can improve the usefulness of the vehicle, but the addition of the object can cause problems when the object increases the overall size of the vehicle such that the vehicle can no longer pass through a space, such as an entrance to a garage, after the object is added to the vehicle. Often, the vehicle will be able to pass through the space if the object is not present on the vehicle, but cannot fit through the space when the object is attached to the vehicle. A driver may not realize that the object will prevent the combination of the vehicle and the object from fitting through the space, such as an entrance to a garage, and the driver may attempt to drive through the space with the object attached to the vehicle. The result can be a collision between the object on the vehicle and a structure that defines the space. This collision can be a costly mistake that damages the vehicle and the object attached to the vehicle. It is desirable to avoid these types of collisions.

### SUMMARY OF THE DESCRIPTION

The methods and systems for forward clearance guidance for vehicles are described in this disclosure. The methods and systems can use data from sensors on a vehicle along with data about an object that is attached to the vehicle to determine whether there is sufficient clearance in the expected path of the vehicle to allow the vehicle and the attached object to pass or fit through a space, such as a garage entrance, in the expected path.

A method in one embodiment can include the following operations: receiving object data representing an object size which includes at least one of a height or a width of an object placed on a vehicle; storing the object data for use by a data processing system coupled to the vehicle; capturing a set of one or more data (such as images) using a set of one or more sensors (such as cameras) on the vehicle, the set of one or more cameras coupled to the data processing system to provide image data from which the data processing system is configured to determine a size of a space in an expected path of travel of the vehicle; and comparing, by the data processing system, the size of the space to the object size to determine whether the vehicle, with the object placed on the vehicle, can pass through the space. In one embodiment, the data processing system can generate a warning, such as a warning on a user interface on a touchscreen display, to the driver that the vehicle may not fit in response to determining, from the comparison, that the vehicle may not fit through the space. In one embodiment, the data processing system can cause the vehicle to stop or change its path if the vehicle continues on the path toward the space after the warning has been generated and presented to the driver. In one embodiment, the warning can include a selectable user interface that allows the vehicle's user to invoke driving assistance for guiding the vehicle through the space if possible. If this user interface is selected, the data processing system can control the steering, motor(s) and brakes to autonomously drive the vehicle through the space if it is possible to fit through the space, even when the fit is tight. In one embodiment, the method can further include generating, from a LiDAR system on the vehicle which is coupled to the data processing system, ranging data from which the data processing system is configured to determine the distance to the space from both the images and the ranging data. In one embodiment, the object data can be received through a mobile application on the driver's smart phone, and the mobile application can be configured to provide the object data to the data processing system through either a wired interface or a wireless interface. In one embodiment, the driver can enter the object data through a user interface on the mobile application which includes an on-screen keyboard. In another embodiment, the object data can be obtained from a captured image of the object on the vehicle, where the captured image is obtained through a camera on the driver's smart phone. In one embodiment, the driver's smart phone can be also configured to unlock the vehicle and allow the vehicle to be operated.

In one embodiment, a driver can manually enter on a smart phone, the height of an object mounted on the roof of the vehicle, for example the height of a bicycle or kayak or other object on the vehicle. Alternatively, the application (app) on the smart phone can have a menu of possible things to place on the roof or other portion of the vehicle and the possible heights of those objects. In this case the driver can pick one from the options which are displayed by the app. For example, the average bicycle heights could be shown on the app on the smart phone. The app could give the driver examples of different types of bicycles from which the driver can select the appropriate bicycle. The application could also provide a choice of the type of roof rack. For luggage, the application can list the possible types and brands of luggage that can be on the roof of the vehicle allowing the user to select from the various options one or more of the types or brands of luggage depending on what has been stowed on top of the vehicle. For kayaks, the application can allow the driver to enter the brand name of the kayak which can automatically determine the height of the kayak based on the driver's selection.

In one embodiment, an assisted driving system can include: a vehicle having a set of one or more cameras to capture a set of one or more images that show an expected path of travel of the vehicle; an interface configured to receive object data from a mobile device, wherein the object data represents an object size which includes at least one of a height or a width of an object placed on the vehicle; a data processing system coupled to the interface to receive and store the object data and coupled to the set of one or more cameras, the data processing system configured to determine a size of a space in the expected path and configured to determine whether the vehicle, with the object placed on the vehicle, can fit through the space. In one embodiment, the interface can be one of a wired connection or a wireless connection such as a Bluetooth connection. The data processing system can be coupled to a display device and the data processing system can generate a warning which is displayed on the display device, wherein the warning indicates that the vehicle may not pass through the space. In one embodiment, the data processing system can be configured to cause the vehicle to stop or change its path if the vehicle continues on the path toward the space after the warning is generated. In one embodiment, the data processing system can be a set of one or more data processing systems which are coupled together to provide assisted driving features including, forward clearance guidance as described herein. In one embodiment, the assisted driving feature can help guide the vehicle (by controlling the steering and the motor(s) and the brakes) through the space if it is possible to fit the vehicle (with any attachments) through the space. In one embodiment, the assisted driving system can further include a LiDAR system that is coupled to the data processing system, wherein the data processing system receives ranging data from the LiDAR system and is configured to use the ranging data from the LiDAR system to determine a distance to the space. In one embodiment, the object data can be received through a mobile application on the driver's smart phone, and the mobile application is configured to provide the object data to the data processing system through the interface. In one embodiment, the driver can enter the object data through a user interface on the mobile application, such as through a on-screen keyboard of the mobile application on the driver's smart phone. In another embodiment, the object data can be obtained from a captured image of the object on the vehicle, where the captured image was obtained through a camera on the smart phone when the driver took a picture of the object on the vehicle using the smart phone's camera. In one embodiment, the driver's smart phone can be configured to unlock the vehicle and allow the vehicle to be operated. The vehicle can include a set of one or more motors and a steering system and a set of braking systems which are coupled to wheels to allow the vehicle to move along the road. The data processing system can be configured to control the motors and braking systems and a steering system to cause the vehicle to stop before the vehicle attempts to enter a restricted space which may cause a collision with an object placed on the vehicle or the vehicle itself.

In one embodiment, the methods and systems described herein can be used for a vehicle even if no object is attached to the vehicle. In this case, a vehicle size (e.g., a width and height at the widest and highest points respectively) can be stored in a non-volatile memory (e.g., flash memory) coupled to a data processing system in the vehicle. The vehicle size can be compared to a size of a space (e.g., an entrance to a garage) in the expected path of travel of the vehicle, and the size of the space can be determined by the data processing system from data from one or more sensors such as a camera(s) and a LiDAR sensor and ultrasonic sensor(s). If the vehicle may not fit or pass through the space, the data processing system can generate a warning to the vehicle's user that the vehicle may not pass through the space. In one embodiment, the warning can be displayed on a touchscreen or heads up display in the vehicle, and the warning can include a selectable user interface element that can invoke driving assistance or fully autonomous driving to attempt to guide or drive the vehicle through the space if possible. If the vehicle's user selects this user interact element, the data processing system can control the motor(s), steering and brakes to attempt to guide the vehicle through the space using data from the sensors such as one or more cameras, a LiDAR sensor, ultrasonic sensors, etc. The data processing system can use data from the sensors to determine the proximity or clearance of different portions of the vehicle relative to the boundaries of the space (such as the door frame of a garage door), and can steer the vehicle in a manner to pass through the space even if the fit is tight; however, as the vehicle approaches the space, the data processing system can move the vehicle at a very slow speed before reaching the space and can use the sensor data to make a final decision whether to continue through the space or stop because the vehicle cannot safely pass through the space.

The embodiments and vehicles described herein can include non-transitory machine readable media that store executable computer program instructions that can cause one or more data processing systems to perform the one or more methods described herein when the computer program instructions are executed by the one or more data processing systems. The instructions can be stored in non-volatile memory such as flash memory or other forms of memory.

The above summary does not include an exhaustive list of all embodiments in this disclosure. All systems and methods can be practiced from all suitable combinations of the various aspects and embodiments summarized above, and also those disclosed in the Detailed Description below.

### BRIEF DESCRIPTION OF THE DRAWINGS

The present embodiments are illustrated by way of example and not limitation in the figures of the accompanying drawings in which like references indicate similar elements.

FIG. 1 (FIG. 1) shows an example of a vehicle with an object placed on top of the vehicle.

FIG. 2 (FIG. 2) shows, in block diagram form, an example of an assisted driving system which can provide forward clearance guidance.

FIG. 3 (FIG. 3) shows, in a top view, a vehicle which includes a set of sensors that can be configured to provide forward clearance guidance.

FIG. 4 (FIG. 4) shows an example of a captured image from a forward-looking camera on a vehicle, such as the vehicle shown in FIG. 3.

FIG. 5 (FIG. 5) shows an example of an assisted driving system which can provide forward clearance guidance as described herein.

FIG. 6 (FIG. 6) shows an example of how a forward clearance guidance system in one embodiment can include information about a slope of a ramp which may lead to a restricted space such as an entrance to a garage.

FIG. 7 (FIG. 7) is a flowchart which shows a method according to one embodiment described herein.

### DETAILED DESCRIPTION

Various embodiments and aspects will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments.

Reference in the specification to “one embodiment” or “an embodiment” means that a particular feature, structure, or characteristic described in conjunction with the embodiment can be included in at least one embodiment. The appearances of the phrase “in one embodiment” in various places in the specification do not necessarily all refer to the same embodiment. The processes depicted in the figures that follow are performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

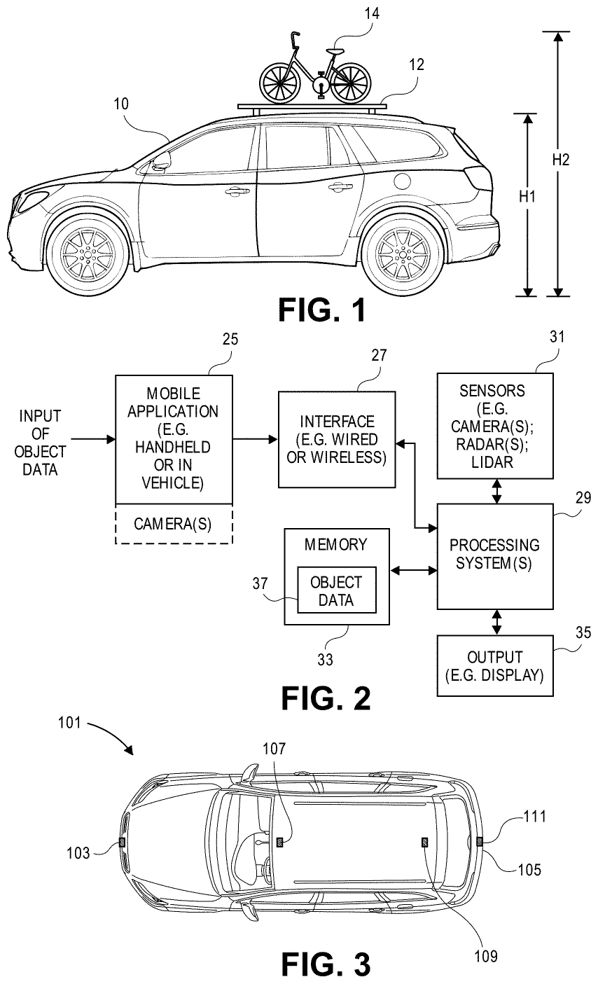

FIG. 1 shows an example of a vehicle 10 which includes a rack 12 that can hold an object on top of the vehicle 10. In the example shown in FIG. 1, a bicycle 14 has been placed on top of the vehicle 10 and can be secured to the rack 12. The bicycle can add considerable height to the combination of the vehicle and the bicycle such that the height increases from H1 to H2 as shown in FIG. 1. The driver can determine the height of the bicycle 14 and enter that height into a mobile application on the driver's smart phone as described herein to provide forward clearance guidance. Alternatively, the driver can use the camera on the driver's smart phone to capture an image of the bike on the rack and the application on the smart phone can determine the height of the bicycle or other object from the captured image in one embodiment. In one embodiment, the application on the driver's smart phone can present a list of possible sizes for a bike and allow the user to select one of those options or sizes to store as the size of the bike for use by a data processing system as further described herein. In one embodiment, the vehicle's user can enter the object's size into an application on the vehicle or send the object's size to the vehicle through a connection between the vehicle and a data processing system.

FIG. 2 shows an example of an assisted driving system which operates with a mobile application which can be a mobile app on the driver's smart phone in one embodiment or can be an application built into the vehicle in another embodiment. The mobile application 25 can execute on the driver's smart phone and provide forward clearance guidance as described herein by allowing the driver to enter information about an object placed on the vehicle. In one embodiment, the user can type the size into the mobile application 25 which operates on the driver's smart phone. In another embodiment, the driver can select from a set of displayed sizes on the mobile application 25 to cause the storage of data about the object which represents the object size. In another embodiment, the smart phone can include one or more cameras which can be used by the driver to capture an image of the object attached to the vehicle, and the captured image can be used to derive the size of the object using reference information that is known by the mobile application (or by an application in the vehicle) about the vehicle. For example, the length of the vehicle or the height of the vehicle can be a reference size which is used to derive or determine the size of the object on the vehicle such as the height or the width of the object on the vehicle. The object data which is obtained from the user or from the camera can be supplied to the vehicle through an interface 27 which can be a wired interface or a wireless interface. For example, the interface 27 can be a Bluetooth interface or can be a USB wire connecting the driver's smart phone to the vehicle's data processing systems. The interface 27, in one embodiment, can be used to allow exchanges of data between the smart phone and the vehicle's data processing systems; for example, the interface 27 can allow playback, through the vehicle's speaker system and display system, of audio (and other) content from the smart phone and can allow a user interface of the vehicle to control applications executing on the smart phone. In one embodiment, the interface 27 can include a wireless or wired connection that supports this exchange of data and metadata and controls or commands so that the vehicle's user interfaces (e.g. one or more touchscreens) can control operations on the smart phone and vice versa.

The processing systems 29 can be a set of one or more processing systems which receive the object data and which uses the object data in conjunction with data from sensors 31 to determine whether the vehicle with the object on the vehicle can pass through a restricted space, such as an entrance to a garage or a tunnel, etc. The interface 27 can receive the object data representing the size of the object which is attached to the vehicle and provide that object data to the processing systems 29 which can then store the object data in memory 33. The object data 37 in memory 33 can be used during operation (e.g. movement) of the vehicle by the one or more processing systems such as the processing system 29. The processing system 29 can be coupled to one or more sensors 31 which can be a set of one or more cameras, one or more ultrasonic sensors, one or more radar sensors, and a LiDAR sensor. In one embodiment, all such sensors can be used together to provide a level of accuracy and redundancy that may not be possible with just one type of sensor. The one or more cameras can be used to capture images from which the size of a restricted space, such as the entrance of a garage, can be calculated. The size can be calculated using a reference distance known to the data processing system, such as the length of the front hood of a vehicle. The one or more cameras can provide image data while the radar systems, such as radar sensors which can be part of sensors 31, can provide distance information and the LiDAR sensor can provide distance information as well as image information in one embodiment. The processing system 29 can be configured to process the data from the sensors to determine the size of a restricted space and distance and compare that size to the size represented by the object data 37 stored in memory 33 in one embodiment.

When the processing system determines that the size of the object on the vehicle is larger than the height of the restricted space or larger than another measurement of the restricted space then the processing system can cause a warning to be displayed on an output, such as the output 35 which can be a display device or a set of speakers in the passenger compartment of the vehicle, etc. The warning can indicate to the driver that the car will not or may not safely pass through or fit through the restricted space which is in the expected path of the vehicle based upon the vehicle's current trajectory. In one embodiment, the object data 37 may include a tolerance value or error budget in order to accommodate mistakes in measurements. For example, the object data 37 may include a larger amount (such as 3% or 6% larger) for a measurement than the actual measurements supplied by the driver. In this example, if the actual measurement was 100 mm (supplied by the driver) and the tolerance value is based on 3%, then the object data may be set at 103 mm. In one embodiment, the tolerance value can be based upon a known level of uncertainty or range of possible errors in the one or more sensors that are used to measure the restricted space. In one embodiment, the processing system 29 can be coupled to one or more motors which are coupled to the wheels of the vehicle and can also be coupled to one or more braking systems and one or more steering systems which are coupled to the wheels of the vehicle. The processing system 29 in one embodiment can control the motors and steering system and the braking system to cause the vehicle to stop if the driver does not heed the warning that the vehicle will not safely pass through the restricted space. In one embodiment, the distance to the restricted space and the vehicle's current speed can be used to determine whether to intervene and stop the vehicle by using an autonomous driving system to control the motors and brakes to stop the vehicle.

The processing systems described herein, such as processing system 29 and processing systems 201, can provide in one embodiment assisted driving functionality, in which the vehicle assists the vehicle's user/driver, or autonomous driving, in which the vehicle controls steering, braking and movement through one or more motors without requiring input from the vehicle's user/driver. In one embodiment, a warning message that the vehicle may not be able to pass through a space, such as an entrance into a garage, can include a selectable user interface element that the vehicle's user can select to invoke an assisted driving functionality or autonomous driving to attempt to guide the vehicle through the space. The warning message and the selectable user interface element can be displayed on a touchscreen in the vehicle, and the vehicle's user can select the selectable user interface element by touching the element to invoke either an assisted driving functionality or autonomous driving. Once invoked, either the assisted driving functionality or autonomous driving can attempt to guide or drive the vehicle through the space if possible by controlling steering, brakes and motor(s) to attempt to guide the vehicle through the space using data from the one or more sensors, such as one or more cameras, a LiDAR sensor, a radar sensor, and ultrasonic sensors. The data processing system(s) in the vehicle can use the data from the one or more sensors to determine the clearance of different portions of the vehicle (e.g. right side, left side and top of vehicle) relative to the boundaries of the space (such as the door frame of a garage door), and this data about the clearance can be used to steer the vehicle in a manner to safely pass through the space (if possible) even if the space is a tight fit. The steering, under assisted driving or autonomous driving, can attempt to center the vehicle within a portion of the perceived space that appears to have enough clearance on all sides of the vehicle. In one embodiment, this centering operation can be performed iteratively in a process in which the data processing systems in the vehicle move the vehicle and concurrently measure the clearances and then adjust the steering to maintain sufficient and similar clearance on all sides and then again move and measure and then adjust the steering to maintain sufficient and similar clearance around the vehicle. If, during this process as the vehicle approaches the space, a clearance falls to nearly zero (or within a measurement tolerance error of zero) or below zero, then the data processing system can stop the vehicle before reaching the space and abandon the attempt to guide the vehicle through the space; moreover, in one embodiment, the vehicle's user can stop the vehicle by manually stepping on a brake pedal in the vehicle even if the vehicle is using autonomous driving to guide the vehicle. In one embodiment, the data processing system(s) of the vehicle can automatically invoke guidance through the space without displaying a selectable user interface element, and this automatic invoking of guidance can occur whenever the measured clearance around different portions of the vehicle falls below a threshold value.

FIG. 3 shows an example of a vehicle 101 which can include a set of sensors that can be configured to provide forward clearance guidance as described herein. The vehicle 101 can include a forward-looking camera 107 and a rearward looking sensor 109. Moreover, the vehicle 101 can include a set of sensors 103 on the front bumper of the car, and these sensors can include a LiDAR sensor, radar sensors and ultrasonic sensors. In addition, the vehicle 101 can include a set of sensors 111 on the rear bumper 105 of the vehicle. The set of sensors 111 can include one or more of radar sensors and/or a LiDAR sensor in one embodiment. In one embodiment, the sensors 31 shown in FIG. 2 can be the same as the set of sensors shown in FIG. 3.

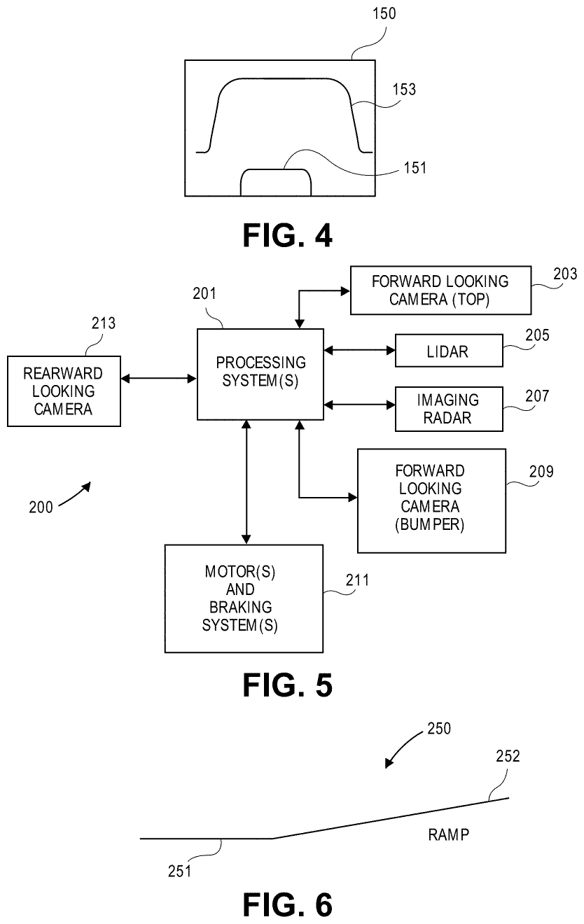

FIG. 4 shows an example of an image 150 which can be an image captured by the forward-looking camera which is part of the sensors 31 in FIG. 1, such as the forward-looking camera 107 shown in FIG. 3. The image 150 shows a restricted space 153 which can, for example, be an entrance to a garage. The image 150 also includes an image of a portion of the vehicle on which the forward-looking camera is mounted. For example, the forward-looking camera 107 can capture in its images a portion of the hood of the vehicle. As shown in FIG. 4, the front hood 151 is partially shown in the image 150, and this can provide a known reference size which can be used to determine the sizes (such as a width and height) of the restricted space 153. In the example shown in FIG. 4, there appears to be enough width for the vehicle to travel through the restricted space 153 but the height of the restricted space 153 may not be sufficient enough to allow the vehicle with a bicycle or other object attached to the top of the vehicle to pass through the restricted space 153. A processing system, such as the processing system 29 in FIG. 1 can use the known size of the front hood 151 of the vehicle to derive or determine sizes of the restricted space 153 using techniques known in the art based upon the image data such as the image 150.

FIG. 5 shows an example of an assisted driving system that can be used in one embodiment. The assisted driving system shown in FIG. 5 can be used with the set of sensors shown in FIG. 3 to provide forward clearance guidance as described herein. The processing systems 201 can be a set of one or more processing systems that are configured to receive data from the one or more sensors on the vehicle and process that data in order to provide assisted driving such as forward clearance guidance. The processing systems 201 can be coupled to memory, which can be similar to memory 33 which stores object data, such as object data 37 about an object attached to the vehicle. The assisted driving system 200 shown in FIG. 5 can include a forward-looking camera 203, a LiDAR sensor 205, a set of imaging radar sensors 207, and another forward-looking camera 209 which can be mounted on the bumper of the vehicle. The forward-looking camera 203 can be mounted on the roof of the vehicle, such as the forward-looking camera 107 shown in FIG. 3. The forward-looking camera 203 can be configured to capture a portion of the front hood of the vehicle so that the size which is known to the data processing system of the front hood of the vehicle in the captured images can be used as a reference size that can be used to derive or determine sizes of a restricted space in the expected path of the vehicle. In one embodiment, the set of sensors shown in FIG. 5 can be used in combination to provide better accuracy than a single sensor and also provide redundancy. In one embodiment, the assisted driving system 200 can also include ultrasonic sensors on the front bumper to provide information (e.g. distance) about objects in front of the vehicle's expected path of travel.

The LiDAR sensor 205 and the set of imaging radar sensors 207 can provide information with respect to the distance remaining to the restricted space which can be used by the processing system to determine when it should take action if the driver fails to heed the warning that the vehicle cannot pass through the restricted space. Further, ranging data from the LiDAR sensor 205 and ranging data from the one or more imaging radar sensors 207 (and optionally forward looking ultrasonic sensors) can be used to provide distance information that can be used to calculate the sizes of the restricted space based upon the distance. As is known in the art, the further away the restricted space is relative to the vehicle, the smaller it will appear in the image, and thus the distances provided by the ranging data can be used when the processing system(s) 201 calculates the size of the width and height of the restricted space, such as the restricted space 153. The assisted driving system 200 can also include a rearward looking sensor 213 (such as a camera). In one embodiment, the processing systems 201 can be coupled to one or more motors and a steering system and one or more braking systems on the vehicle. The one or more motors and a steering system and the one or more braking systems 211 can be coupled to wheels to allow the vehicle to move along a road. The processing system(s) 201 can control the motors and the braking systems to cause the vehicle to stop before attempting to pass through a restricted space in one embodiment. The vehicle can be a conventional gasoline powered vehicle or can be a battery powered vehicle or a hybrid vehicle that uses both gasoline and battery power to provide energy to motors to move the vehicle.

In one embodiment, the forward-looking camera, such as forward-looking camera 203 or forward-looking camera 107 can provide an angle of a ramp of the road in the expected path of the vehicle. This angle or slope can be used by a data processing system when calculating whether there is sufficient space to pass through or fit through a restricted space, such as restricted space 153. The angle data from the forward-looking camera can be used in combination with the calculated size of the restricted space to determine whether there is sufficient vertical clearance for the vehicle to continue along its expected path through the restricted space. FIG. 6 shows, in a side view, a road 250 which includes a ramp 252. The level section 251 of the road 250 leads to the ramp 252.

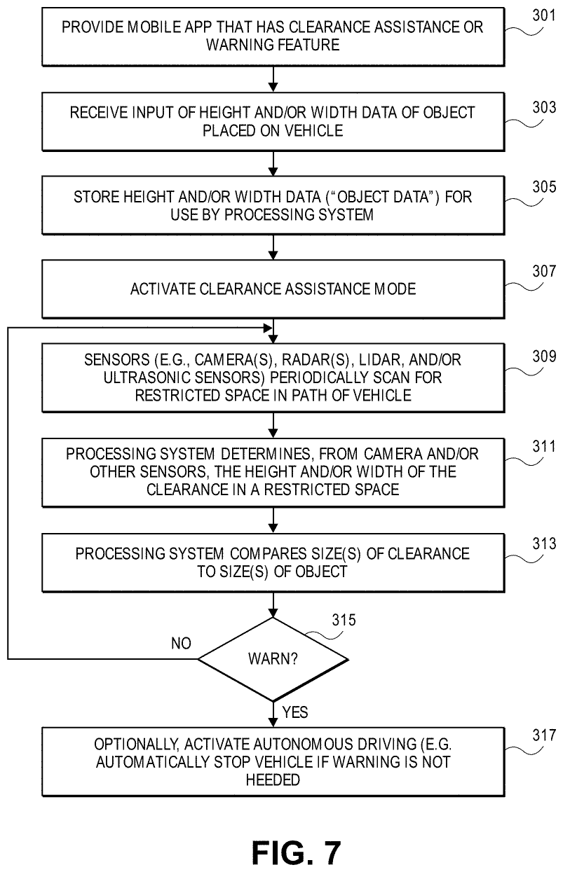

An example of a method, which can use the embodiments of the assisted driving systems described herein, will now be provided while referring to FIG. 7. The method shown in FIG. 7 can use the assisted driving system 200 shown in FIG. 5 or the assisted driving system shown in FIG. 2. In operation 301, a mobile application can be provided to a driver, and the mobile application can include a clearance assistance feature. In one embodiment, the mobile application can be designed for use with the vehicle and include information about the vehicle and can be configured to exchange information with data processing systems in the vehicle. In one embodiment, the mobile application may also provide other features for using the vehicle, such as the ability to unlock the vehicle or start the vehicle when the phone is in proximity to the vehicle. The mobile application may be configured to receive object data, such as the size of an object attached to the vehicle through a user interface on the smart phone, such as through a on-screen keyboard that allows keyboard input by the driver which specifies the size of an object attached to the vehicle. In another embodiment, the application may present a list of sizes from which the user or driver can select. In another embodiment, the user may use the camera on the smart phone to capture an image of the object on the vehicle to provide object data through that image. Operation 303 shows an example of how the object data can be entered into the vehicle through an interface between the smart phone and the vehicle. Once the object data is received, it can be stored in operation 305 for use by one or more processing systems on the vehicle. Then in operation 307 the clearance assistance mode can be activated. This may be an optional step (e.g., the driver is required to activate it in order to use clearance guidance) or may occur automatically as a result of receiving the object data about an object attached to the vehicle. During operation (e.g., movement) of the vehicle, the processing system can cycle through operations 309, 311, 313 and 315 while the vehicle is traveling along an expected path. In operation 309, one or more sensors, such as one or more cameras, one or more radar sensors, and a LiDAR sensor and one or more ultrasonic sensors can periodically scan for restricted space in the expected path of the vehicle. The expected path of the vehicle is a trajectory in one embodiment which is calculated from the current velocity and direction of movement of the vehicle.

In operation 311, the one or more processing systems can determine, from the camera data and/or data from other sensors the height and width of the clearance of a restricted space such as the height and width of a garage entrance. Then in operation 313, the one or more processing systems can compare the size of the clearance to the size of the vehicle with the attached object to determine whether there is sufficient clearance for the vehicle and the object to safely pass through or fit through the restricted space. If the processing system determines there may not be enough clearance, then the processing system will decide in operation 315 that a warning should be provided to the driver. If the clearance is sufficient, the processing system returns to operation 309 to continue cycling through operations 309, 311, 313, and 315. If the warning is presented as a result of operation 315, the data processing system can further perform operation 317 which can be optional in one embodiment. Operation 317 can involve the activation of autonomous driving which can include automatically stopping the vehicle if the warning is not heeded or attempting to pass through the space by guiding the vehicle through the space (if possible) by using autonomous driving.

If the vehicle includes autonomous driving capabilities, the activation of autonomous driving in one embodiment can be either immediate (after operation 313) or delayed if there is sufficient time to allow the driver to respond to the warning by stopping the vehicle. The data processing system(s) in the vehicle can use the vehicle's current speed and the distance to the restricted space to determine when the vehicle will enter the restricted space; for example, if the vehicle's current speed is 20 feet per speed and the restricted space is about 80 feet in front of the vehicle, the data processing system(s) have at least three seconds before potential impact, and may allow the driver one or two seconds before activating autonomous driving (to stop the vehicle or attempt to guide the vehicle through the space under the control of autonomous driving).

While this description has focused on objects attached to the vehicle, in other embodiments, the methods and systems described herein can be used for the vehicle itself without any objects attached to the vehicle, and thus the assisted driving system can determine if the vehicle (by itself) is too wide or too high for a restricted space. In this other embodiment, the vehicle can store data about the vehicle size (such as width, height and length), and use that data in a comparison to data about the size of a space in the path of travel of the vehicle. When that comparison indicates a tight fit, a warning can then be presented as described herein and assisted driving guidance or autonomous driving can be invoked (either manually or automatically).

While this description has focused on the use of different measurements, such as the width and height of the vehicle and the width and height of the space, it will be appreciated that other measurements or other approaches can be used in other embodiments. For example, a size matching algorithm that matches images of the same scale (in terms of pixels in the image per meter or other measurement unit of the object in the image) may be used to compare an image of the space to an image (or representation of an image) of the vehicle. The match in effect compares the sizes of objects in each image at the same scale to determine whether the vehicle can fit through the space. The image of the vehicle can be taken and stored by the vehicle's manufacturer for use in this size matching algorithm.

It will be apparent from this description that embodiments and aspects of the present invention may be embodied, at least in part, in software. That is, the techniques and methods may be carried out in a data processing system or set of data processing systems in response to one or more processors executing a sequence of instructions stored in a storage medium, such as a non-transitory machine readable storage media, such as volatile DRAM or nonvolatile flash memory. In various embodiments, hardwired circuitry may be used in combination with software instructions to implement the embodiments described herein. Thus the techniques and methods are not limited to any specific combination of hardware circuitry and software, or to any particular source for the instructions executed by the one or more data processing systems.

In the foregoing specification, specific exemplary embodiments have been described. It will be evident that various modifications may be made to those embodiments without departing from the broader spirit and scope set forth in the following claims. The specification and drawings are, accordingly, to be regarded in an illustrative sense rather than a restrictive sense.

What is claimed is:

1. A machine implemented method comprising:
receiving object data representing an object size of an object placed on a vehicle;
storing the object data for use by a data processing system coupled to the vehicle;
capturing a first set of data using a set of one or more sensors on the vehicle, the set of one or more sensors coupled to the data processing system to provide data from which the data processing system is configured to determine a size of a space in an expected path of travel of the vehicle;
comparing, by the data processing system, the size of the space to the object size to determine whether the vehicle, with the object placed on the vehicle, can pass through the space.

2. The method as in claim 1, further comprising:
generating, through a user interface, a warning to the vehicle's user that the vehicle will not pass through the space in response to determining, from the comparing, that the vehicle will not pass through the space.

3. The method as in claim 2, wherein the first set of data comprises one or more images and the set of sensors includes one or more cameras, and wherein the method further comprises:
causing the vehicle to stop or change its path if the vehicle continues on the path toward the space after the warning is generated.

4. The method as in claim 3, wherein the method further comprises:
generating, from a LiDAR system or other sensors on the vehicle and coupled to the data processing system, ranging data from which the data processing system is configured to determine the distance to the space from both the images and the ranging data.

5. The method as in claim 4, wherein the object data is received through a mobile application on the vehicle user's smart phone and the mobile application is configured to provide the object data to the data processing system through either a wired connection or a wireless connection.

6. The method as in claim 5, wherein the vehicle's user enters the object data through a user interface on the mobile application.

7. The method as in claim 5, wherein the object data is a captured image of the object on the vehicle, the captured image obtained through a camera on the vehicle user's smart phone.

8. The method as in claim 5, wherein the vehicle user's smart phone is configured to unlock the vehicle and allow the vehicle to be operated.

9. The method as in claim 4 wherein the other sensors that generate ranging data include one of radar sensors or ultrasound sensors, and wherein the data processing system is coupled to one or more braking systems to stop or slow the vehicle and is coupled to a steering system to steer the vehicle.

10. An assisted driving system comprising:
a vehicle having a set of one or more sensors to capture a first set of data that show an expected path of travel of the vehicle;
an interface configured to receive object data from a mobile device, the object data representing an object size of an object placed on the vehicle;
a data processing system coupled to the interface to receive and store the object data and coupled to the set of one or more sensors, the data processing system configured to determine a size of a space in the expected path and to determine whether the vehicle, with the object placed on the vehicle, can fit through the space.

11. The assisted driving system as in claim 10 wherein the interface comprises one of a wired connection or a wireless connection.

12. The assisted driving system as in claim 11, wherein the data processing system is coupled to a display device and wherein the display device displays a warning generated by the data processing system in response to determining that the vehicle will not fit through the space.

13. The assisted driving system as in claim 12 wherein the data processing system is configured to cause the vehicle to stop or change its path if the vehicle continues on the path toward the space after the warning is generated.

14. The assisted driving system as in claim 13, further comprising a LiDAR system or other sensors coupled to the data processing system, wherein the data processing system is configured to use ranging data from the LiDAR system or other sensors to determine a distance to the space.

15. The assisted driving system as in claim 14 wherein the object data is received through a mobile application on the vehicle user's smart phone and the mobile application is configured to provide the object data to the data processing system through the interface.

16. The assisted driving system as in claim 15 wherein the user enters the object data through a user interface on the mobile application.

17. The assisted driving system as in claim 15 wherein the object data is a captured image of the object on the vehicle, the captured image obtained through a camera on the smart phone.

18. The assisted driving system as in claim 16 wherein the vehicle user's smart phone is configured to unlock the vehicle and allow the vehicle to be operated.

19. A non-transitory machine-readable medium storing executable computer program instructions which when executed by one or more data processing systems cause the one or more data processing systems to perform a method comprising:
receiving object data representing an object size of an object placed on a vehicle;
storing the object data for use by a data processing system coupled to the vehicle;
capturing a first set of data using a set of one or more sensors on the vehicle, the set of one or more sensors coupled to the data processing system to provide data from which the data processing system is configured to determine a size of a space in an expected path of travel of the vehicle;
comparing, by the data processing system, the size of the space to the object size to determine whether the vehicle, with the object placed on the vehicle, can pass through the space.

20. The medium as in claim 19, wherein the method further comprises:
generating, through a user interface, a warning to the vehicle's user that the vehicle will not fit in response to determining, from the comparing, that the vehicle will not fit.

21. The medium as in claim 20 wherein the first set of data comprises one or more images and the set of one or more sensors includes one or more cameras and wherein the method further comprises:
causing the vehicle to stop or change its path if the vehicle continues on the path toward the space after the warning is generated.

22. The medium as in claim 20 wherein the object data is received through a mobile application on the vehicle user's smart phone and the mobile application is configured to provide the object data to the data processing system through either a wired connection or a wireless connection and wherein the vehicle's user enters the object data through a user interface on the mobile application.

23. The medium as in claim 22 wherein the vehicle user's smart phone is configured to unlock the vehicle and allow the vehicle to be operated.

24. A non-transitory machine-readable medium storing executable computer program instructions which when executed by a data processing system cause the data processing system to perform a method comprising:
storing data representing a vehicle size of a vehicle, the data representing the vehicle size being stored in a non-volatile memory on the vehicle, the non-volatile memory coupled to a data processing system;
capturing a first set of data using a set of one or more sensors on the vehicle, the set of one or more sensors coupled to the data processing system to provide data from which the data processing system is configured to determine a size of a space in an expected path of travel of the vehicle;
comparing the size of the space to the vehicle size to determine whether the vehicle can pass through the space.

25. The medium as in claim 24, wherein the method further comprises:
generating, through a user interface, a warning to the vehicle's user that the vehicle may not pass through the space in response to determining, from the comparing, that the vehicle may not pass through the space.

26. The medium as in claim 25, wherein the method further comprises:
causing, through control of a braking system or a steering system by the data processing system, the vehicle to stop or change its path if the vehicle continues on the path toward the space after the warning is generated.

27. The medium as in claim 26 wherein the vehicle size includes a tolerance value that is based on an uncertainty or range of possible errors in the set of one or more sensors that provide data used to determine the size of the space.

28. The medium as in claim 25 wherein the data processing system is coupled to one or more braking systems and one or more steering systems and to one or more motors to autonomously drive the vehicle or to assist in driving the vehicle and wherein the data processing system provides at least driving assistance if the vehicle continues on the path toward the space after the warning is generated, and the driving assistance guides the vehicle through the space if it can fit through the space.

29. The medium as in claim 28 wherein the warning includes a user interface to allow the vehicle's user to invoke driving assistance for guiding the vehicle through the space if possible.
